(19) United States
(12) Patent Application Publication
(10) Pub. No.: US 2015/0350755 A1
(43) Pub. Date: Dec. 3, 2015

(54) Method And Apparatus For The Management Of Remote Nodes In A Communication Network

(71) Applicant: Alcatel-Lucent USA Inc., Murray Hill, NJ (US)

(72) Inventors: Michael Shaffer, Longwood, FL (US); Rex Coldren, Phoenix, AZ (US)

(73) Assignee: ALCATEL-LUCENT USA INC., Murray Hill, NJ (US)

(21) Appl. No.: 14/578,735

(22) Filed: Dec. 22, 2014

Related U.S. Application Data
(60) Provisional application No. 62/003,726, filed on May 28, 2014.

(51) Int. Cl. H04Q 11/00

(52) U.S. Cl. CPC H04Q 11/0067; H04Q 11/0003; H04Q 2011/0079

(57) ABSTRACT

A manner of performing remote-node management, for example the management of ONUs in a PON. In that type of optical network, a management node such as an OLT determines that a management command is to be transmitted and also determines the management protocol associated with the management command. A management message is generated, the management message having a header with a device identifier field. When the management message is generated, the device identifier field is populated with a value indicating whether the management command is associated with a default protocol or with an alternate protocol. The value in the device identifier field may identify specific alternate protocols so that when the manage device, for example an ONU in a PON, received the management message it may be directed to an appropriate interface point.

### CROSS-REFERENCE TO RELATED APPLICATIONS

The present disclosure is related to and claims priority from U.S. Provisional Patent Application Ser. No. 62/003,726, entitled Supporting Disparate Management Protocols over a Single Interface and filed on 28 May 2014, the entire contents of which are incorporated by reference herein.

### TECHNICAL FIELD

The present invention relates generally to the field of communication networks, and, more particularly, to a method and apparatus for managing remote devices in an optical communications network.

### BACKGROUND

The following abbreviations are herewith expanded, at least some of which are referred to within the following description of the state-of-the-art and the present invention.

### DOCSIS Data Over Cable Service Interface Specification

### GEM GPON Encapsulation Method

### GPON Gigabit PON

### IEEE Institute of Electrical and Electronics Engineers

### ITU International Telecommunication Union

### LAN Local Area Network

### OAM Operation, Administration, and Maintenance

### OLT Optical Line Terminal

### OMCI ONT Management and Control Interface

### ONT Optical Network Unit

### ONU Optical Network Unit

### PDU Protocol Data Unit

### PON Passive Optical Network

### SDN Software Defined Network

### SNMP Simple Network Management Protocol

### VLAN Virtual LAN

### XG-PON 10G-PON

An optical network, for example, a PON (passive optical network) may be used as an access network, connecting individual subscribers or groups of subscribers to a core telecommunications network. A typical PON includes, among other components, an OLT (optical line terminal) in a CO (central office) and a number of ONUs (optical network units) at subscriber premises (or some intermediate location). Many residential houses, for example, have an ONU that communicates with an OLT over a FTTH (fiber to the home) PON access network. The network may make available to the subscriber services such as Internet access, telephone, and television. Other optical network may be similarly configured such as that a management node such as an OLT may communicate with multiple end devices, for example in a data center.

ONUs and similar devices in an optical network may be managed from the central office by a management node such as an OLT or related device. This management may include, for example, upgrading an ONU, diagnosing and fixing a problem, or simply checking the status of a managed device. In a PON, management commands may be transmitted from an OLT to an ONU using a standard interface. The numerous new applications for which such networks may now be employed, however, introduces the need to efficiently transmit management commands associated with various management protocols. Present solutions are often inadequate and may compromise network security. A novel solution is therefore described herein.

Note that the techniques or schemes described herein as existing or possible are presented as background for the present invention, but no admission is made thereby that these techniques and schemes were heretofore commercialized or known to others besides the inventors.

### SUMMARY

Various solutions presented herein are directed to the remote management of managed devices in optical communication networks such as various types of PONs (passive optical networks).

In one aspect, a method of remote-node management in an optical network is described, the method including determining that a management command should be directed to a managed device, determine the management protocol associated with management command, and generating a management message comprising a header and the management command, wherein the message header comprises a device identifier field having a unique value identifying the management message protocol. The method may further include transmitting the management message.

In a preferred embodiment, the method of remote-node management is employed in a PON and the management message is generated in an OLT. In this embodiment, the management message may be an OMCI message, where the management command may be included in the OMCI message as a PDU, particularly if it is not a basic (or enhanced) OMCI format management command. Non-OMCI management commands may be alternate-protocol commands and in some embodiments, an OMCI message header comprises a message type field including a value indicating whether the OMCI message includes a non-OMCI format PDU.

In some embodiments, the method may also include receiving the management message in a managed device such as an ONU, parsing the management header to determine the value contained in a device identifier header, and directing the management message to an appropriate interface point in the managed node for processing and eventual execution.

In another aspect, apparatus for remote-node management is described, the apparatus including a processor, a memory in communication with the processor, and a message generator configured to generate a message comprising a message header including device identifier including a value for indicating whether the message is an alternate-protocol message. The apparatus may also include a transmitter for transmitting the management message.

In a preferred embodiment, these components are implemented in an OLT for a PON, and the message generator is configured to generate OMCI messages for transmitting management commands to an ONU. The message generator may also be configured to generate a message including a message header having a message type field including a value indicating whether the OMCI message includes a non-OMCI format PDU such as may be associated with SNMP or Ethernet OAM. The apparatus may also include an ONU configured to examine the value contained in a device identifier field of the message header and direct the management message to an interface point.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selecting selected components of a typical PON in which embodiments of the present invention may be implemented;

FIG. 2 is a flow diagram illustrating a remote-management method according to an embodiment of the present invention;

FIG. 3 is a flow diagram illustrating a remote-management method according to an embodiment of the present invention;

FIG. 4 is a simplified block diagram illustrating selected components of an OLT according to an embodiment of the present invention; and

FIG. 5 is a simplified block diagram illustrating selected components of an ONU according to an embodiment of the present invention.

### DETAILED DESCRIPTION

Various exemplary embodiments will now be described, and in general they are directed to an advantageous manner of managing devices in a communication network. Specifically, a managing node sends management messages to one or more, and frequently many managed devices. The managed devices may operate uniformly according to one uniform management protocol, but increasingly this is not the case. The described embodiments offer a manner of performing management operations using differing or mixed management protocols, which will sometimes be referred to herein as “alternate protocols”.

This solution may be advantageously applied, for example, in an optical access network such as a PON (passive optical network). Note that the term “PON” is herein intended to be inclusive of all such networks, including for example GPON and XG-PON. Note, however, that the solutions presented herein may also be employed in other types of optical networks. An exemplary PON will now be described and used as an illustration of the methods and apparatus of the proposed solutions.

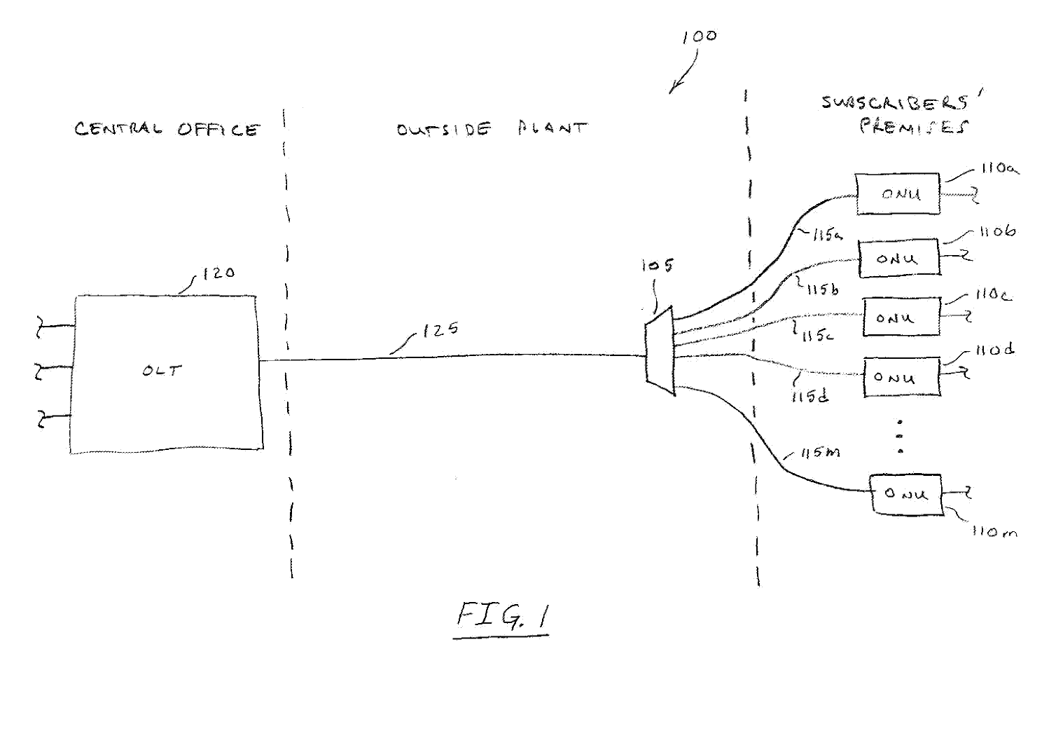

FIG. 1 is a simplified schematic diagram illustrating selecting selected components of a typical PON 100 in which embodiments of the present invention may be implemented. Note that PON 100 may, and in many implementations will, include additional components, and the configuration shown in FIG. 1 is intended to be exemplary rather than limiting. Five ONUs, 110a through 110m, are shown, although in a typical PON there may be many more or, in some cases, fewer. In this illustration, each of the ONUs are presumed to be located at and serving a different subscriber, perhaps at their respective residences or other premises. The ONU at each location is connected or connectable to a device of the subscriber, or to a network of such devices (not shown). In some other cases (not shown) an ONU may be associated with multiple subscribers and ultimately service a number of subscriber devices. As used herein, the term “ONU” is considered to include ONTs (optical network terminals) and similar devices.

PON 100 also includes an OLT 120, which communicates directly or indirectly with various sources of content and network-accessible services (not shown) that are or may be made available to the subscribers associated with PON 100. As should be apparent, OLT 120 handles the communications between these other entities and the ONUs. OLT 120 may also be involved in regulating the PON and individual ONUs. As mentioned above, the OLT 120 is typically located at a service provider location referred to as a central office. The central office may house multiple OLTs (not separately shown), each managing their own respective PON.

OLT 120 is in at least optical communication with each of the ONUs in the PON 100. In the embodiment of FIG. 1, OLT is connected with the ONUs 110a through 110n via a (feeder) fiber optic cable 125 and (access) fiber optic cables 115a through 115m. In this PON, a single splitter 105 is used to distribute a downstream transmission so that each ONU receives the same downstream signal. In this case, each ONU extracts and uses only its own portion of the downstream transmission.

In other optical networks, the splitter may also separate the signal into different wavelengths, if used, associated with each or various of the respective ONUs. The splitter in a PON is typically a passive element requiring no power. The splitter may be located, for example, in a street-side cabinet near the subscribers it serves (FIG. 1 is not necessarily to scale). This cabinet or similar structure may be referred to as the outside plant. Note, however, that no particular network configuration is a requirement of the present invention unless explicitly stated or apparent from the context.

In the example of FIG. 1, the splitter may also serve as a combiner for combining upstream traffic from the ONUs 110a through 110m to the OLT 120. Upstream transmissions are generally at a different wavelength (or wavelengths) than those of downstream transmissions to avoid interference. In addition, each ONU may be assigned a separate time slot, that is, a schedule for making upstream transmissions.

In addition to the transmission of data, certain management communications are also exchanges. In a typical scenario, ONUs are numerous and widely distributed, meaning that performing on-site maintenance is inconvenient and costly. For this reason a managing node such as an OLT may transmit management messages to, for example, inquire about the status of an ONU, fix problems, and perform routine upgrades. In PON systems, including for example GPON, XG-PON, and NGPON, as specified by ITU-T an OMCI (ONT Management and Control Interface) is used for transmitting management. Each ONU is presumed capable of recognizing the management messages, sometimes referred to as OAM (Operations, Administration, Maintenance) messages.

As PON-type applications increase for example into DOCSIS, FTTdp (fiber to the distribution point), and SDN (software defined) architectures, issues arise with the possibility of needing to accommodate of differing or mixed management protocols. One possibility would be require each ONU to support an IP stack and acquire its own IP address, but this is impracticable due to security and space management concerns. It is also possible to use additional GEM ports and VLANs to perform either LAN-based layer 2 access to the ONU or point-to-point control between the OLT and the ONU. Here, however, no uniform interface is thereby provided, and incompatible interfaces may again raise security issues.

To address these concerns, the PON 100 of FIG. 1 may implement an enhanced OMCI for transmitting management messages from the OLT to an ONU. This interface will now be described in more detail.

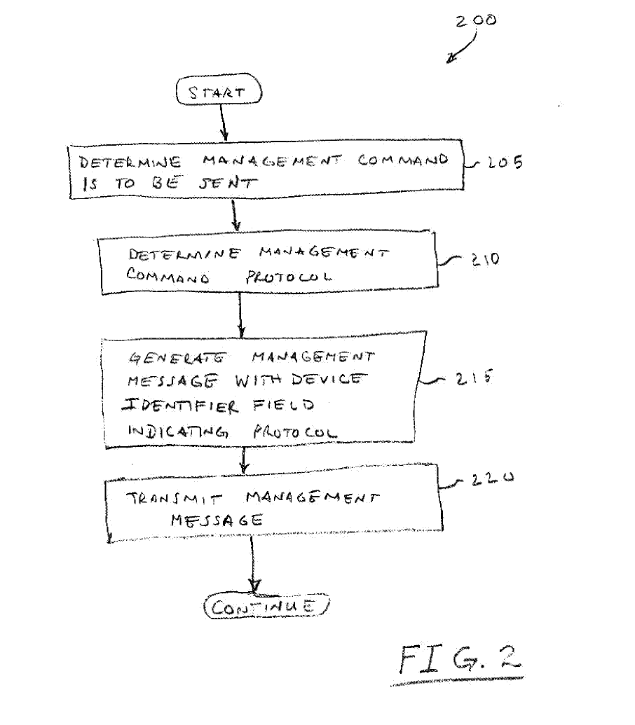

FIG. 2 is a flow diagram illustrating a remote-management method 200 according to an embodiment of the present invention. At START it is presumed that the necessary components are available and operational according to at least this embodiment. The process according to this embodiment then begins when a management node determines (step 205) that a management command is to be sent to a managed device. In the context of a PON, for example the PON illustrated in FIG. 1, the management device may be an OLT and the managed device may be an ONU. The determination of step 205 may take place, for example, according to a schedule, upon the receipt of an instruction or other message from another component of an operator, or upon the occurrence of another triggering event.

In the embodiment of FIG. 2, when it is determined in step 205 that a management command should be sent, the management node determines (step 210) whether the message is associated with an alternate management protocol. As used herein, an “alternate management protocol” implies that there exists a default or standard protocol and that any particular management message may be associated with it or not. In a preferred embodiment, the default is a standard OMCI message format.

In the embodiment of FIG. 2, after it is determined at step 210 whether the management command to be transmitted is an alternate-protocol message, a management message is generated (step 215) with a header indicating the management command protocol. In a preferred embodiment, the management message is an OMCI message with a header having a device field indicating the applicable management protocol.

For example, at step 215 an OMCI message may be generated having in its header a device identifier field bearing a value indicating that the message is associated with an SNMP (simple network management protocol) device or, alternately, with an Ethernet OAM device. Of course, the management command in some cases may not be an alternate-protocol management command and, and then the device identifier field may, for example, bear a value indicating that the message is associated with an OMCI basic device, or alternately with an OMCI extended device.

In the embodiment of FIG. 2, when the management message is generated at step 215, the management command is incorporated. For example, for an OMCI management message an existing message set may be used, or in the case of an alternate-protocol message the management command may be incorporated using a generic PDU (protocol data unit) container.

In a preferred embodiment, the management message generated at step 215 also includes a header having a message type field bearing a value indicating whether the management message incorporates an alternate-protocol management command. For example, the message type field may bear a value indicating whether the remainder of the OMCI is an OMCI format, or alternately that it is a non-OMCI format PDU. The use of a message type field in this manner is not a requirement, however, unless explicitly recited in a particular embodiment.

Finally, in the embodiment of FIG. 2, the generated management message is transmitted (step 220) toward the managed node. In the PON environment, the OLT transmits the management message to an ONU. In some implementations, the OLT will await an acknowledgement and retransmit if none is received (not shown in FIG. 2), otherwise, the process continues when another management command is to be sent. Note that the operations of FIG. 2 are not necessarily performed in a single component but may be performed by a number of components working in concert.

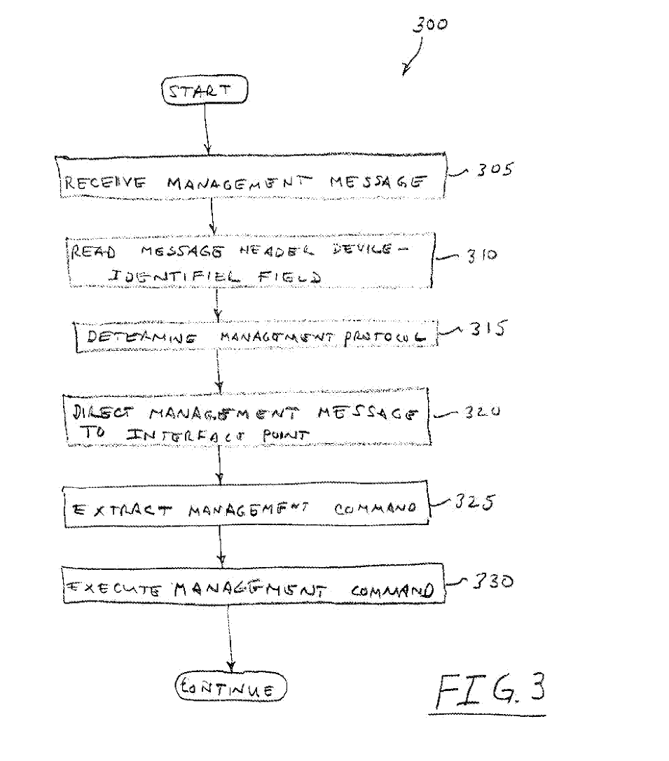

FIG. 3 is a flow diagram illustrating a remote-management method 300 according to an embodiment of the present invention. At START it is presumed that the necessary components are available and operational according to at least this embodiment. The process according to this embodiment then begins when a managed node receives (step 305) a management message. Again, in a preferred embodiment, the management message is an OMCI message including a message header. In a PON environment, the managed node is an ONU.

When a management message is received in step 305, the managed reads the message header (step 310) and determines (step 315) to which interface point the message will be directed. In accordance with this embodiment of the present invention, this determination is made by examining the device identifier field. The received management message is then directed (step 320) to the appropriate interface point where it is parsed (step 325) to extract then management command. The management command is then executed (step 330). In some implementations the managed node may send an acknowledgment (not shown in FIG. 3) that the management message has been received.

Note that the sequences of operation illustrated in FIGS. 2 and 3 represent exemplary embodiments; some variation is possible within the spirit of the invention. For example, additional operations may be added to those shown in FIGS. 2 and 3, and in some implementations one or more of the illustrated operations may be omitted. In addition, the operations of the method may be performed in any logically-consistent order unless a definite sequence is recited in a particular embodiment.

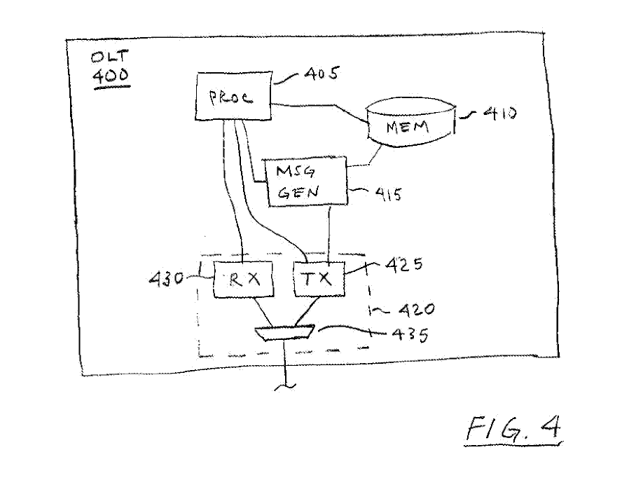

FIG. 4 is a simplified block diagram illustrating selected components of an OLT 400 according to an embodiment of the present invention. In this embodiment OLT 400 includes a processor 405, which may control any or all of the other elements of the OLT 400. Processor 405 may be implemented, for example, in hardware or in hardware executing program instructions stored on memory 410. Similarly, unless explicitly stated otherwise memory 410 is storage medium implemented in hardware or in hardware executing program instructions and is non-transitory in the sense of not being merely a propagating signal. Memory 410 may also be used to store data and program instructions for the operation of other components. In other embodiments, more than one processor or memory device may be used to perform the functions described herein.

In the embodiment of FIG. 4, OLT 400 also includes a message generator 415 for generating management messages. Message generator 415 is configured to generate message in accordance with one of the processes described in reference to FIG. 2, above and may be implemented, for example, in hardware or in hardware executing program instructions stored on memory 410.

In this embodiment, optical module 420 includes a transmitter 425 and a receiver 430. The transmitter includes a light source (not separately shown) such as a laser, and the receiver includes a light detector such as a photodiode (also not separately shown). Splitter/combiner 435 allows the transmitter and receiver 430 to respectively send and receive communications over a common medium (such as feeder fiber 425 shown in FIG. 1). Messages generated by message generator 415 are transmitted by transmitter 425.

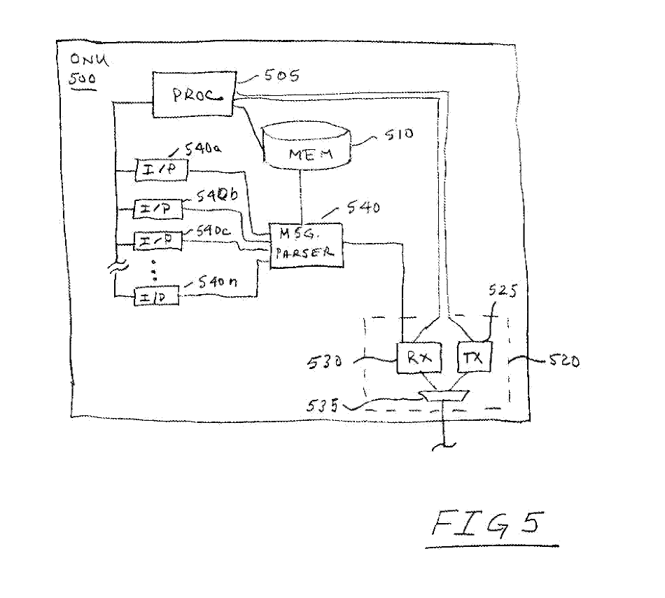

FIG. 5 is a simplified block diagram illustrating selected components of an ONU 500 according to an embodiment of the present invention. In this embodiment OLT 500 includes a processor 505, which may control any or all of the other elements of the ONU 500. Processor 505 may be implemented, for example, in hardware or in hardware executing program instructions stored on memory 510. Similarly, unless explicitly stated otherwise memory 510 is storage medium implemented in hardware or in hardware executing program instructions and is non-transitory in the sense of not being merely a propagating signal. Memory 510 may also be used to store data and program instructions for the operation of other components. In other embodiments, more than one processor or memory device may be used to perform the functions described herein.

In this embodiment, optical module 520 includes a transmitter 525 and a receiver 530. The transmitter includes a light source (not separately shown) such as a laser, and the receiver includes a light detector such as a photodiode (also not separately shown). Splitter/combiner 535 allows the transmitter and receiver 530 to respectively send and receive communications over a common medium (such as one of the access fibers 115 shown in FIG. 1). Management messages, for example, may be received by receiver 530.

In the embodiment of FIG. 5, ONU 500 also includes a management message header parser 540. When a management message is received at receiver 535, it is examined by header parser 540 to determine the value in the device identifier field (and in some embodiments in the message type field). The management message may then be passed to one of interface points 540a through 540n as appropriate for the management protocol associated with the value contained in the device identifier field (or in some cases the message type field, or both). Note that although three interface points are depicted in FIG. 5, there may be any number.

Note also that the components depicted in FIGS. 4 and 5 are exemplary, and other configurations are possible. In some embodiments, additional components are also present. Components illustrated in FIG. 5 may in some cases be integrated with each other or further divided into separate components that together perform a particular function. The illustrated components may also perform other functions in addition to those described above.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of remote-node management in an optical network, comprising:
determining that a management command should be directed to a managed device;
determine the management protocol associated with management command; and
generating a management message comprising a header and the management command, wherein the message header comprises a device identifier field having a unique value identifying the management message protocol.

2. The method of remote-node management of claim 1, further comprising transmitting the message.

3. The method of remote-node management of claim 1, wherein the optical network is a PON the management message is generated in an OLT.

4. The method of remote-node management of claim 1, wherein the management message is an OMCI message.

5. The method of remote-node management of claim 4, wherein the management command is included in the OMCI message as a PDU.

6. The method of remote-node management of claim 5, wherein the OMCI message header comprises a message type field including a value indicating whether the OMCI message includes a non-OMCI format PDU.

7. The method of remote-node management of claim 1, wherein determining the management protocol associated with management command comprises determining whether the management command is an alternate-protocol management command.

8. The method of remote-node management of claim 7, wherein the device identifier field includes a value indicating that the device is a SNMP device.

9. The method of remote-node management of claim 8, wherein the device identifier field includes a value indicating that the device is an Ethernet OAM device.

10. Apparatus for remote node management, comprising:
a processor;
a memory in communication with the processor; and
a message generator, wherein the message generator is configured to generate a message comprising a message header including device identifier including a value for indicating whether the message is an alternate-protocol message.

11. The apparatus of claim 10, further comprising a transmitter for transmitting the message.

12. The apparatus of claim 10, wherein the apparatus comprises an OLT in communication with a PON.

13. The apparatus of claim 10, wherein the management message is an OMCI message.

14. The apparatus of claim 10, wherein the alternate-protocol message is included in the OMCI message as a PDU.

15. The apparatus of claim 14, wherein the OMCI message header comprises a message type field including a value indicating whether the OMCI message includes a non-OMCI format PDU.

16. The apparatus of claim 10, wherein the device identifier field includes a value indicating that the device is a SNMP device.

17. The apparatus of claim 10, wherein the device identifier field includes a value indicating that the device is an Ethernet OAM device.

18. The apparatus of claim 10, further comprising an ONU.

19. The apparatus of claim 18, wherein the ONU comprises a management message header parser configured to examine the value contained in a device identifier field of the message header and direct the management message to an interface point.
